(19) United States
(12) Patent Application Publication
(10) Pub. No.: US 2009/0059074 A1
(43) Pub. Date: Mar. 5, 2009

(54) Display apparatus

(75) Inventors: Masayuki Suematsu, Chiba (JP); Takayuki Ohe, Saitama (JP); Masato Usuki, Kanagawa (JP); Masanari Yamamoto, Kanagawa (JP); Kenkichi Kobayashi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/229,374

(22) Filed: Aug. 22, 2008

(30) Foreign Application Priority Data
Aug. 31, 2007 (JP) P2007-225758

(51) Int. Cl. H04N 5/50

(52) U.S. Cl. 348/569

(57) ABSTRACT

A display apparatus including an image processing unit for performing a frame rate conversion process of converting a frame rate using an interpolating image generated based on a motion vector between adjacent frames with respect to a picture signal which is a collection of image signals of a plurality of frame units taken along a time-series; and a display unit for displaying a picture based on the picture signal of after the frame rate conversion process; wherein the image processing unit performs the frame rate conversion process using an image at least one part of which is the same as a frame immediately before as the interpolating image when an OSD superimposed picture signal having an OSD image signal superimposed on an input picture signal is input to the frame rate conversion section.

### CROSS-REFERENCE TO RELATED APPLICATION

The present invention contains subject matter related to Japanese Patent Application JP 2007-225758 filed in the Japan Patent Office on Aug. 31, 2007, the entire contents of which being incorporated herein by reference.

### BACKGROUND OF THE INVENTION

1. Field of the Invention

The present invention relates to a display apparatus having a frame rate conversion function of converting a display cycle of a picture signal to a display cycle different from an input signal.

2. Description of the Related Art

In recent years, display apparatuses such as television receiver, cam coder, and digital still camera generally have an OSD (On Screen Display) function in which a menu screen for carrying out operations such as adjustment of position in a horizontal direction and a vertical direction, correction of distortion, and adjustment of contrast and brightness, or an image of channel numbers, volume and the like is displayed superimposed on a picture to be viewed.

In such display apparatuses, a frame rate conversion process of converting a frame rate, which is a display cycle of a picture signal, to a display cycle different from the input signal is also performed mainly in an aim of improving blurs etc. of the liquid crystal caused by the visual features of humans (see e.g., Japanese Patent Application Laid-Open No. 2006-78505). Specifically, the display apparatus performs a frame interpolation process of generating an interpolating image based on a motion vector between adjacent frames, and mixing an image signal of the generated interpolating image with an input picture signal, with respect to the input input picture signal.

### SUMMARY OF THE INVENTION

However, in the display apparatus with the OSD function, if the picture signal superimposed with the image signal (hereinafter, referred to as “OSD image signal”) of the OSD image of the menu screen, the channel number, the volume and the like is frame rate converted, the motion vector may not be obtained for the OSD image portion since the OSD image exists independently of the input image. An issue thus arises in that false operation occurs in the frame interpolation process at the edge etc. of the OSD image due to influence of the moving portion in the input image to be frame interpolation processed based on the motion vector.

In view of the above issues, it is desirable to provide a display apparatus with a frame rate conversion function of converting a display cycle of a picture signal to a display cycle different from an input signal, where false operation in frame rate converting the picture signal superimposed with the OSD image signal is prevented.

According to an embodiment of the present invention, there is provided, a display apparatus including an image processing unit for performing a frame rate conversion process of converting a frame rate using an interpolating image generated based on a motion vector between adjacent frames with respect to a picture signal which is a collection of image signals of a plurality of frame units taken along a time-series; and a display unit for displaying a picture based on the picture signal of after the frame rate conversion process.

The image processing unit includes a control section for outputting a superimpose command signal representing a command to superimpose an OSD image signal for performing an OSD display on an input picture signal which is the picture signal input from an outside, an OSD superimposing section, externally input with the input picture signal, for outputting an OSD superimposed picture signal having the OSD image signal superimposed on the input picture signal or the input picture signal according to an input of the superimpose command signal from the control section, and a frame rate conversion section for performing the frame rate conversion process on the OSD superimposed picture signal or the input picture signal input from the OSD superimposing section; where the frame rate conversion section performs the frame rate conversion process using an image at least one part of which is the same as a frame immediately before as the interpolating image when a conversion control signal indicating that the OSD superimposed picture signal is input to the frame rate conversion section is input from the control section.

The frame rate conversion section may perform the frame rate conversion process using an image where only the OSD display portion is the same as the frame immediately before as the interpolating image when the conversion control signal is input.

The frame rate conversion section may perform the frame rate conversion process using an image where only a region to be performed with the predefined OSD display is the same as the interpolating image when the conversion control signal is input.

The frame rate conversion section may perform the frame rate conversion process using an image entirely the same as the frame immediately before as the interpolating image when the conversion control signal is input.

According to another embodiment of the present invention, there is provided a display apparatus including an image processing unit for performing a frame rate conversion process of converting a frame rate using an interpolating image generated based on a motion vector between adjacent frames with respect to a picture signal which is a collection of image signals of a plurality of frame units taken along a time-series; and a display unit for displaying a picture based on the picture signal of after the frame rate conversion process.

The image processing unit includes a control section for outputting a superimpose command signal representing a command to superimpose an OSD image signal for performing an OSD display on an input picture signal which is the picture signal input from an outside, an OSD superimposing section, externally input with the input picture signal, for outputting an OSD superimposed picture signal having the OSD image signal superimposed on the input picture signal or the input picture signal according to an input of the superimpose command signal from the control section, and a frame rate conversion section for performing the frame rate conversion process on the OSD superimposed picture signal or the input picture signal input from the OSD superimposing section; where the frame rate conversion section performs the frame rate conversion process using an image at least one part of which is the same as a frame immediately before as the interpolating image when a conversion control signal indicating that the OSD superimposed picture signal is input to the frame rate conversion section is input from other external equipment of the display apparatus.

The frame rate conversion section may perform the frame rate conversion process using an image where only the OSD display portion is the same as the frame immediately before as the interpolating image when the conversion control signal is input.

The frame rate conversion section may perform the frame rate conversion process using an image where only a region to be performed with the predefined OSD display is the same as the interpolating image when the conversion control signal is input.

The frame rate conversion section may perform the frame rate conversion process using an image entirely the same as the frame immediately before as the interpolating image when the conversion control signal is input.

According to another further embodiment of the present invention, there is provided a display apparatus including an image processing unit for performing a frame rate conversion process of converting a frame rate using an interpolating image generated based on a motion vector between adjacent frames with respect to a picture signal which is a collection of image signals of a plurality of frame units taken along a time-series; and a display unit for displaying a picture based on the picture signal of after the frame rate conversion process.

The image processing unit includes a control section for outputting a superimpose command signal representing a command to superimpose an OSD image signal for performing an OSD display on an input picture signal which is the picture signal input from an outside, an OSD superimposing section, externally input with the input picture signal, for outputting an OSD superimposed picture signal having the OSD image signal superimposed on the input picture signal or the input picture signal according to an input of the superimpose command signal from the control section, a frame rate conversion section for performing the frame rate conversion process on the OSD superimposed picture signal or the input picture signal input from the OSD superimposing section, and an OSD superimposition detecting section for detecting the input of the OSD superimposed picture signal to the frame rate conversion section; where the frame rate conversion section performs the frame rate conversion process using an image at least one part of which is the same as a frame immediately before as the interpolating image when a conversion control signal indicating that the OSD superimposed picture signal is input to the frame rate conversion section is input from the OSD superimposition detecting section.

The frame rate conversion section may perform the frame rate conversion process using an image where only the OSD display portion is the same as the frame immediately before as the interpolating image when the conversion control signal is input.

The frame rate conversion section may perform the frame rate conversion process using an image where only a region to be performed with the predefined OSD display is the same as the interpolating image when the conversion control signal is input.

The frame rate conversion section may perform the frame rate conversion process using an image entirely the same as the frame immediately before as the interpolating image when the conversion control signal is input.

According to the display apparatus of the embodiments of the present invention having the above configuration, if false operation occurs as a result of performing the frame rate conversion process on the input image signal superimposed with the OSD image signal, the interpolation process using motion vector is not performed at least for the OSD image portion without motion between the adjacent frames and the previous input image signal itself is used as the interpolation image signal in the frame rate conversion section. Therefore, the generation of a mistaken interpolation image signal is suppressed, the stable interpolated image signal can be output, and false operation can be prevented.

According to the embodiments of the present invention, false operation that occurs as a result of performing the frame rate conversion on the picture signal superimposed with the OSD image signal can be prevented by performing an exceptional process of generating an interpolating image independent of the motion vector when performing the frame rate conversion process on the picture signal superimposed with the OSD image signal.

### BRIEF DESCRIPTION OF THE DRAWINGS

FIG. 1 is a block diagram showing a function configuration of a general display apparatus;

FIG. 2 is an explanatory view showing an example of a false operation when a frame rate conversion process is performed on an OSD superimposed picture signal, and an improvement example therefor;

FIG. 3 is a block diagram showing a function configuration of a display apparatus according to a first embodiment of the present invention;

FIG. 4 is a block diagram showing a detailed function configuration of a control section according to the present embodiment;

FIG. 5 is a block diagram showing a detailed function configuration of a frame rate conversion section according to the present embodiment;

FIG. 6 is an explanatory view showing an example of a conversion method of a frame rate conversion process performed by the frame rate conversion section according to the present embodiment;

FIG. 7 is a block diagram showing a hardware configuration of the display apparatus according to the present embodiment;

FIG. 8 is a flowchart showing a flow of process of a picture display method using the display apparatus according to the present embodiment;

FIG. 9 is a flowchart showing a flow of the frame rate conversion process according to the present embodiment;

FIG. 10 is a block diagram showing a function configuration of a display apparatus according to a second embodiment of the present invention;

FIG. 11 is a flowchart showing a flow of the frame rate conversion process according to the present embodiment;

FIG. 12 is a block diagram showing a function configuration of a display apparatus according to a third embodiment of the present invention;

FIG. 13 is a block diagram showing a detailed function configuration of an OSD superimposition detecting section according to the present embodiment;

FIG. 14 is a flowchart showing a flow of the frame rate conversion process according to the present embodiment; and

FIG. 15 is a flowchart showing a flow of the OSD superimposition detecting process according to the present embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [Regarding General Display Apparatus]

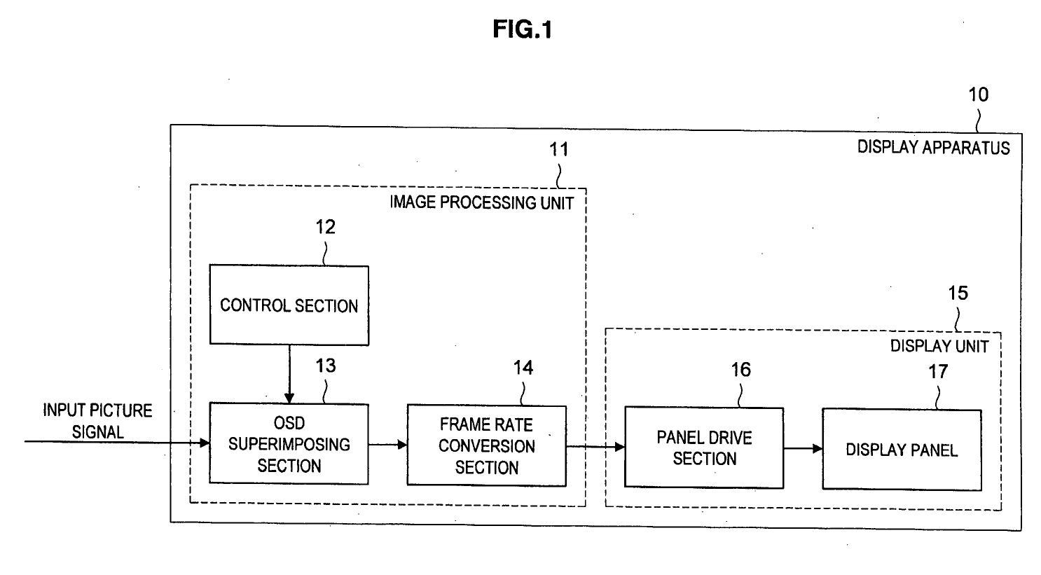

Prior to describing a display apparatus according to each embodiment of the present invention, a general display apparatus 10 will be first described with reference to FIG. 1 as a premise. FIG. 1 is a block diagram showing a function configuration of the general display apparatus 10.

As shown in FIG. 1, the display apparatus 10 includes an image processing unit 11 for performing a frame rate conversion process of converting a frame rate using an interpolating image generated based on the motion vector between adjacent frames with respect to a picture signal which is a collection of image signals in plural frame units along time series; and a display unit 15 for displaying a picture based on the picture signal after frame rate conversion process. More specifically, the image processing unit 11 mainly includes a control section 12, an OSD superimposing section 13, and a frame rate conversion section 14; and the display unit 15 mainly includes a panel drive section 16 and a display panel 17.

The control section 12 receives commands such as input switching of switching an input source of the image signal, channel switching of switching the channel of a program corresponding to the image signal, display of the OSD image, and the like. The control section 12 outputs an image erase command signal according to the command such as input switching and channel switching made from a user through an input unit such as an operation button of a remote controller or a television receiver. The display of an image with image disturbance by the input switching or the channel switching is thereby prevented. The control section 12 outputs to the OSD superimposing section 13 a command (hereinafter, referred to as “superimpose command signal”) of superimposing the OSD image signal for performing OSD display on an input picture signal according to the command of display of the OSD image from the input unit.

The OSD superimposing section 13 superimposes an image signal (hereinafter, referred to as “OSD image signal”) of the OSD (On Screen Display) image such as the channel number and the menu screen on the input picture signal input from an external data transmissible equipment according to the superimpose command signal input from the control section 12. The OSD superimposing section 13 outputs to the frame rate conversion section 14 the picture signal after superimposition (hereinafter, referred to as “OSD superimposed picture signal”) or the externally input input picture signal itself.

The frame rate conversion section 14 performs, on the picture signal input from the OSD superimposing section 13, that is, the OSD superimposed picture signal or the input picture signal, the frame rate conversion process (high frame rate process) of speeding up the frame rate which is the cycle of the relevant picture signal. Specifically, the frame rate conversion section 14 performs a frame interpolation process on the image signal input from the OSD superimposing section 13, and outputs the resultant image signal to the panel drive section 16 as an image signal at a time between the externally input image signals. The frame rate of the picture signal input to the panel drive section 16 thus becomes high speed compared to the frame rate input to the OSD superimposing section 13.

The panel drive section 16 performs processes such as D/A (Digital/Analog) conversion on the picture signal input from the frame rate conversion section 14. The panel drive section 16 drives the display panel 17 such as a liquid crystal panel based on the resultant analog signal, and displays an image in frame units on the display panel 17.

The frame interpolation process applied to the frame rate conversion process performed by the frame rate conversion section 14, a motion compensation process of compensating the motion of the image signal of time series, and the like is a process critical to enhancing the image quality of the image signal of time series. The frame interpolation process includes a process of detecting the motion vector contained in the input image signal of time series, and interpolating the image signal at an arbitrary time between the image signals of time series using the motion vector. The motion vector is detected by comparing the image signals of time series according to the block matching method and the like.

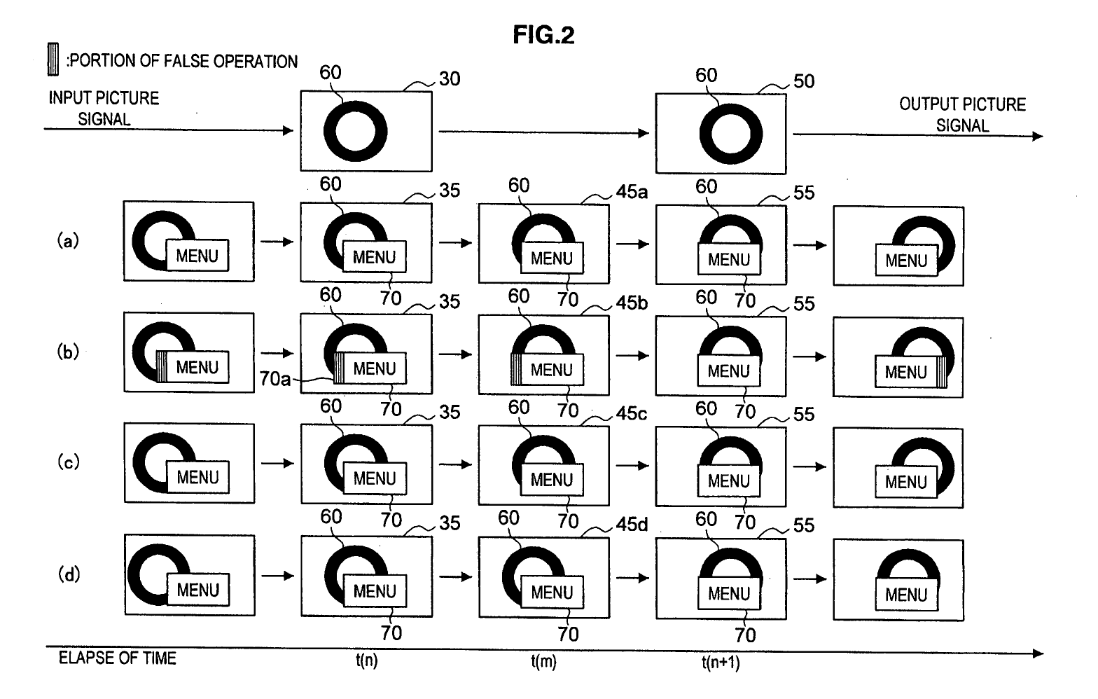

However, in the display apparatus 10 with OSD function of displaying the OSD as described above, if the picture signal superimposed with the OSD image signal of menu screen, channel number, volume, and the like is frame rate converted, the motion vector may not be obtained for the OSD image portion since the OSD image exists independently of the input image. An issue thus arises in that false operation occurs in the frame interpolation process at the edge etc. of the OSD image due to influence of the moving portion in the input image to be frame interpolation processed based on the motion vector. This issue will be described with reference to FIG. 2. FIG. 2 is an explanatory view showing an example of the false operation when the frame rate conversion process is performed on the OSD superimposed picture signal, and an improvement example therefor.

In the example shown in FIG. 2, the input picture signal includes image signals of two images of frame 30 at time t(n) and frame 50 at time t(n+1). The frame 30 and the frame 50 are respectively drawn with a black doughnut-shaped FIG. 60 on a white background. The frame rate conversion process is performed on the OSD superimposed images 35, 55 in which the image signal of the OSD image 70 displaying a menu screen (MENU) is superimposed on the image signals of frame 30 and frame 50. Explaining the frame rate conversion process using a process between time t(n) and time t(n+1) by way of example, an interpolating image 45a at an arbitrary time t(m) between time t(n) and time t(n+1) is generated based on the motion vector detected by comparing the OSD superimposed image 35 and the OSD superimposed image 55, and the interpolating image 45a is inserted between the OSD superimposed image 35 and the OSD superimposed image 55. Originally in this process, only the FIG. 60 moves to the right with elapse of time as shown in the interpolating image 45a of FIG. 2A, and the OSD image 70 is desirably displayed at the same position in an immovable state.

However, in actuality, if the frame rate conversion process is performed on the OSD superimposed images 35, 55 in which the image signal of the OSD image 70 is superimposed, false operation occurs in interpolation at the FIG. 60 moving with elapse of time and the edge 70a of the OSD image 70, as shown in an interpolating image 45 of FIG. 2B. This is because the motion vector is obtained with respect to the portion of the FIG. 60, but the motion vector may not be obtained with respect to the OSD image 70 which exists independent of the input image.

Thus, in the display apparatus according to each embodiment of the present invention described below, if the OSD image 70 is superimposed on the input image, an interpolating image is generated without being based on the motion vector for the portion containing at least the OSD image 70, and an exceptional frame rate conversion process is performed to prevent occurrence of false operation. The display apparatus according to first to third embodiments of the present invention will be hereinafter described in detail.

### First Embodiment

### (Function Configuration of Display Apparatus 100)

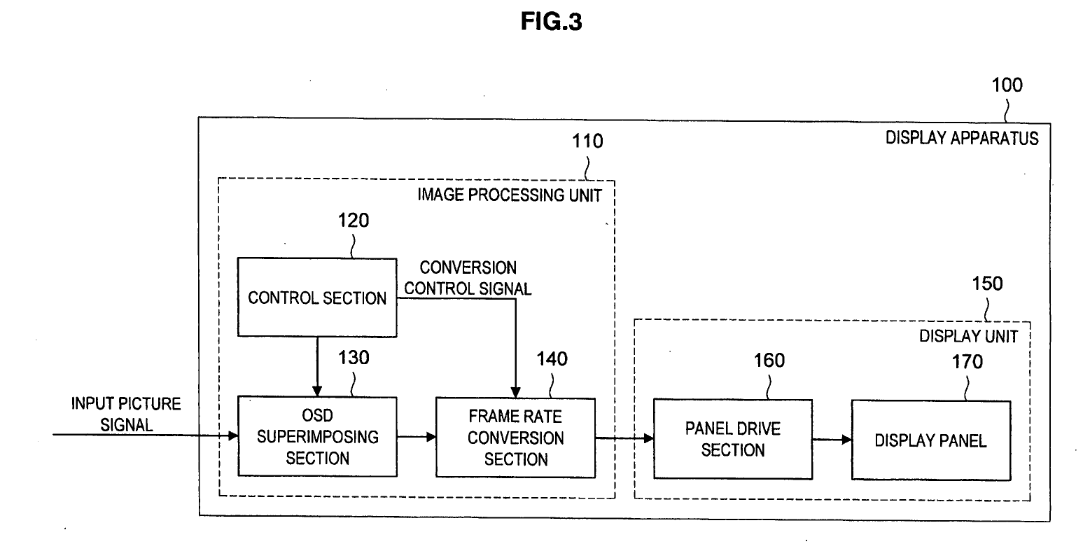

First, the configuration of a display apparatus 100 according to a first embodiment of the present invention will be described with reference to FIG. 3. FIG. 3 is a block diagram showing a function configuration of the display apparatus 100 according to the first embodiment of the present invention.

As shown in FIG. 3, the display apparatus 100 includes an image processing unit 110 for performing a frame rate conversion process of converting a frame rate using an interpolating image generated based on the motion vector between adjacent frames with respect to a picture signal which is a collection of image signals in plural frame units along time series; and a display unit 150 for displaying a picture based on the picture signal after frame rate conversion process. More specifically, the image processing unit 110 mainly includes a control section 120, an OSD superimposing section 130, and a frame rate conversion section 140; and the display unit 150 mainly includes a panel drive section 160 and a display panel 170.

The control section 120 receives commands such as input switching of switching an input source of the image signal, channel switching of switching the channel of a program corresponding to the image signal, display of the OSD image, and the like. The control section 120 outputs an image erase command signal according to the command such as input switching and channel switching made from a user through an input unit such as an operation button of a remote controller or a television receiver. The display of an image with image disturbance by the input switching or the channel switching is thereby prevented. The control section 120 outputs to the OSD superimposing section 130 a command (superimpose command signal) of superimposing the OSD image signal for performing OSD display on an input picture signal according to the command of display of the OSD image from the input unit.

In the display apparatus 100, the control section 120 outputs, in addition to the superimpose command signal, a control signal (hereinafter, referred to as “conversion control signal”) indicating that the OSD image is superimposed on the input picture signal to the frame rate conversion section 140. When the conversion control signal is input, the frame rate conversion section 140 switches the frame rate conversion method from a method using an interpolating image generated based on the motion vector to a method (exceptional process) using an interpolating image not based on the motion vector. The details of the exception process will be hereinafter described, where false operation can be prevented even if the OSD image signal is superimposed on the input picture signal by having the control section 120 output the conversion control signal to the frame rate conversion section 140, and having the frame rate conversion section 140 perform the exceptional process.

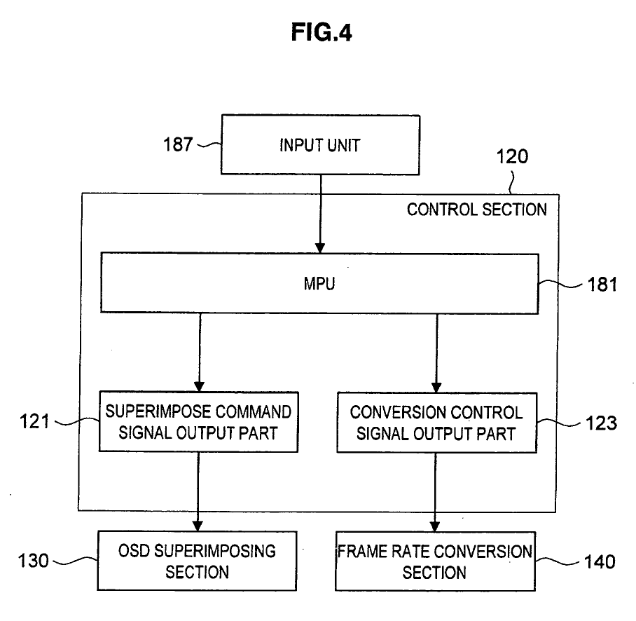

The configuration of the control section will be described in further detail below with reference to FIG. 4. FIG. 4 is a block diagram showing a detailed function configuration of the control section 120 according to the present embodiment.

As shown in FIG. 4, the control section 120 includes an MPU 181, a superimpose command signal output part 121, and a conversion control signal output part 123.

The MPU 181 executes various processes in accordance with the command etc. input from an input unit 187 by executing a program stored in a storage unit (not shown) such as HDD (Hard Disk Drive). The MPU 181 generates the superimpose command signal in correspondence to the command of input switching, channel switching, or display of the OSD image of various adjustments etc. from the input unit 187, and provides the same to the superimpose command signal output part 121. In the present embodiment, the MPU 181 determines whether or not the OSD image is superimposed on the input picture signal, generates the conversion control signal if the OSD image is superimposed on the input picture signal to indicate the same, and provides the same to the conversion control signal output part 123. The determination on whether or not the OSD image is superimposed made by the MPU 181 can be carried out based on whether or not the superimpose command signal is provided to the superimpose command signal output part 121 with respect to the target input picture signal. The MPU 181 can also specify a location (e.g., only OSD image portion, entire input image, predefined region, etc.) to perform the exceptional process in the input image.

The superimpose command signal output part 121 receives the superimpose command signal from the MPU 181, and outputs the same to the OSD superimposing section 130. When the superimpose command signal is input from the superimpose command signal output part 121, the OSD superimposing section 130 superimposes the OSD image signal on the input picture signal.

The conversion control signal output part 123 receives the conversion control signal from the MPU 181, and outputs the same to the frame rate conversion section 140. When the conversion control signal is input from the conversion control signal output part 123, the frame rate conversion section 140 switches the frame rate conversion method to the exceptional process. If the location to perform the exceptional process is specified by the MPU 181, the conversion control signal part 123 can output a signal containing the signal indicating the specified location to the frame rate conversion section 140 as the conversion control signal.

Again referring to FIG. 3, the functions of the OSD superimposing section 130 and the frame rate conversion section 140 to be input with signals from the control section 120 will be hereinafter described.

The OSD superimposing section 130 superimposes an image signal (hereinafter, referred to as “OSD image signal”) of the OSD (On Screen Display) image such as the channel number and the menu screen on the input picture signal input from an external data transmissible equipment according to the superimpose command signal input from the control section 120. The OSD superimposing section 130 outputs to the frame rate conversion section 140 the picture signal after superimposition (hereinafter, referred to as “OSD superimposed picture signal”) or the externally input input picture signal itself.

The frame rate conversion section 140 performs, on the picture signal input from the OSD superimposing section 130, that is, the OSD superimposed picture signal or the input picture signal, the frame rate conversion process (high frame rate process) of speeding up the frame rate which is the cycle of the relevant picture signal. Specifically, the frame rate conversion section 140 performs the frame interpolation process on the image signal input from the OSD superimposing section 130, and outputs the resultant image signal to the panel drive section 160 as an image signal at a time between the externally input image signals. The frame rate of the picture signal input to the panel drive section 160 thus becomes high speed compared to the frame rate input to the OSD superimposing section 130.

The frame interpolation process applied to the frame rate conversion process performed by the frame rate conversion section 140, the motion compensation process of compensating the motion of the image signal of time series, and the like is a process critical to enhancing the image quality of the image signal of time series. The frame interpolation process includes a process of detecting the motion vector contained in the input image signal of time series, and interpolating the image signal at an arbitrary time between the image signals of time series using the motion vector. The motion vector is detected by comparing the image signals of time series according to the block matching method (method of dividing the frame into a plurality of blocks, comparing the image of each block with the image in the search range of the adjacent frame, and detecting the motion vector of the relevant block based on the comparison result) and the like.

When the conversion control signal indicating that the OSD superimposed picture signal is input to the frame rate conversion section 140 is input from the conversion control signal output part 123 of the control section 120, the frame rate conversion section 140 according to the present embodiment performs the frame rate conversion process (exceptional process) using an image, at least one part of which being the same as the frame immediately before, as the interpolating image.

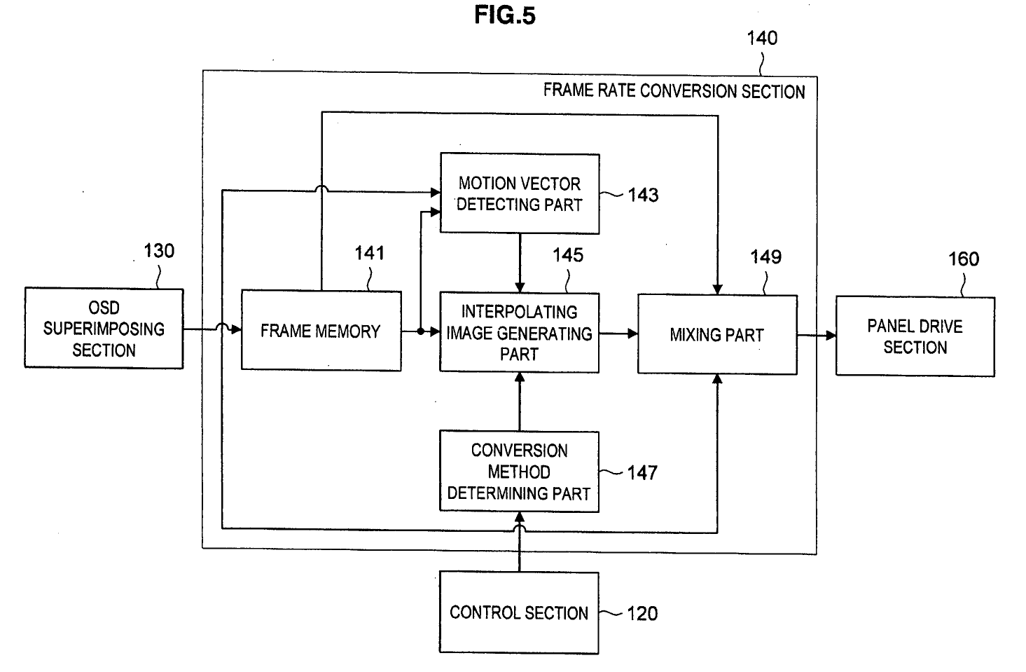

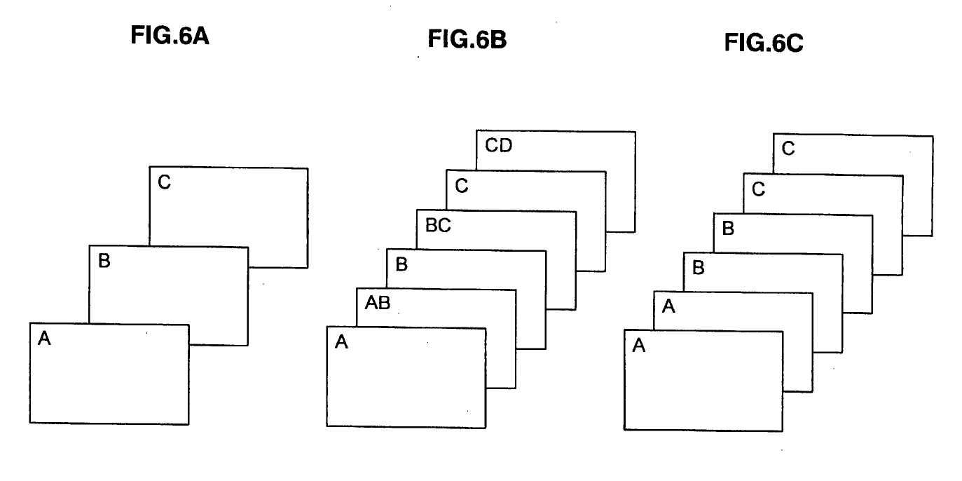

The function of the frame rate conversion section 140 will be described below in further detail with reference to FIGS. 5 and 6. FIG. 5 is a block diagram showing a detailed function configuration of the frame rate conversion section 140 according to the present embodiment, and FIG. 6 is an explanatory view showing an example of a conversion method of the frame rate conversion process performed by the frame rate conversion section 140.

As shown in FIG. 5, the frame rate conversion section 140 includes a frame memory 141, a motion vector detecting part 143, an interpolating image generating part 145, a conversion method determining part 147, and a mixing part 149. The OSD superimposed picture signal from the OSD superimposing section 130 or the input picture signal are provided to the frame memory 141, the motion vector detecting part 143, and the mixing part 149.

The frame memory 141 stores the picture signal (OSD superimposed picture signal or input picture signal) input from the OSD superimposing section 130 in frame units. The frame memory 141 reads out the input image signal stored the previous time, that is, the input image signal of one frame before the input image signal input from the OSD superimposing section 130, and provides the same to the motion vector detecting part 143, the interpolating image generating part 145, and the mixing part 149.

The motion vector detecting part 143 detects, with the image signal contained in the picture signal input from the OSD superimposing section 130 as the input image signal to be detected (hereinafter, referred to as “target input image signal”), the motion vector of the target input image signal. In other words, the motion vector of the target input image signal is detected based on the target input image signal, and an input image signal of one frame before (hereinafter, referred to as “previous input image signal”) the target input image signal provided from the frame memory 141.

The motion vector detecting part 143 detects the motion vector in block units by performing a match of a standard block set for the target input image signal and a reference block of the same size as the standard block set for the previous input image signal according to the block matching method. The motion vector detecting part 143 provides the detected motion vector in block units to the interpolating image generating part 145.

The conversion method determining part 147 determines whether or not the OSD image signal is superimposed on the picture signal input from the OSD superimposing section 130 to the frame rate conversion section 140. The conversion method determining part 147 determines that the OSD image signal is superimposed on the picture signal input from the OSD superimposing section 130 to the frame rate conversion section 140 when the conversion control signal is input from the control section 120 (from the conversion control signal output part 123); and determines that the OSD image signal is not superimposed on the picture signal input from the OSD superimposing section 130 to the frame rate conversion section 140 when the conversion control signal is not input from the control section 120 (from the conversion control signal output part 123). The conversion method determining part 147 then notifies the determination result to the interpolating image generating part 145. The conversion method determining part 147 may not be arranged, and the conversion control signal may be directly input from the control section 120 to the interpolating image generating part 145. In this case, the interpolating image generating part 145 determines whether or not the OSD image signal is superimposed on the picture signal input from the OSD superimposing section 130 to the frame rate conversion section 140.

The interpolating image generating part 145 performs the frame interpolation process according to the determination result of the conversion method determining part 147, and generates the interpolating image.

Specifically, if determined that the OSD image signal is not superimposed on the picture signal input from the OSD superimposing section 130 to the frame rate conversion section 140 by the conversion method determining part 147 (or when the conversion control signal is not directly input from the control section 120), the interpolating image generating part 145 moves the previous input image signal provided from the frame memory 141 in block units using the motion vector in block units provided from the motion vector detecting part 143, and generates an interpolating image which interpolates the image signal at an intermediate time between the target input image signal and the previous input image signal, with respect to the entire input image signal (normal interpolation process).

If determined that the OSD image signal is superimposed on the picture signal input from the OSD superimposing section 130 to the frame rate conversion section 140 by the conversion method determining part 147 (or when the conversion control signal is directly input from the control section 120), the interpolating image generating part 145 performs an exceptional frame rate conversion process (exceptional process) on one part of or all of the input image signal. In other words, the interpolating image generating part 145 uses the previous input image signal provided from the frame memory 141 as it is for the interpolating image signal, and generates an interpolating image which interpolates the image signal at an intermediate time between the target input image signal and the previous input image signal, with respect to one part of or all of the input image (pre-interpolation process).

The pre-interpolation process of the present embodiment has three modes described below.

The first mode is where the frame rate conversion section 140 performs the frame rate conversion process using an image where only the OSD display portion is the same as the frame immediately before as the interpolating image when the conversion control signal is input. That is, in this case, the frame rate conversion section 140 performs the pre-interpolation process only on the OSD image portion, and performs the normal interpolation process using motion vector on other portions. Through such frame rate conversion, the frame rate becomes higher speed without causing false operation and the frame interpolation process can be performed using the motion vector on the moving portions in the input image, and thus blur etc. of the liquid crystal caused by the visual features of humans can be suitably improved.

The second mode is where the frame rate conversion section 140 performs the frame rate conversion process using an image entirely the same as the frame immediately before as the interpolating image when the conversion control signal is input. That is, in this case, the frame rate conversion section 140 performs the pre-interpolation process on the entire input image. Through such frame rate conversion process, the effect of improving blur etc. of the liquid crystal slightly lowers compared to the first mode, but the frame rate becomes higher speed without causing false operation and image quality same as the television receiver of the related art can be maintained.

The third mode is where the frame rate conversion section 140 performs the frame rate conversion process using an image where only the region to be performed with the predefined OSD display is the same as the interpolating image when the conversion control signal is input. That is, in this case, a region where the defined OSD image such as channel display and volume display of the display screen is displayed is defined in advance, only the presence of the OSD image in the defined region is judged, and the pre-interpolation process is performed only on the relevant region if judged that the OSD image is in the region. Through such frame rate conversion process, a portion to be performed with the pre-interpolation process produces in the portion where the OSD image is not displayed if within the above-described region. Thus, the effect of improving blur etc. of the liquid crystal slightly lowers compared to the first mode. However, according to this mode, since the region of performing the pre-interpolation process can be fixed, the conversion method can be changed with only the presence of the OSD image, whereby the conversion control signal input to the frame rate conversion section 140 can be a simple signal.

In the present embodiment, the selection of the mode of the pre-interpolation process described above (location of performing the pre-interpolation process) is made by the conversion control signal output from the control section 120. This selection may be performed in the frame rate conversion section 140.

The interpolating image determining part 145 provides an image signal (hereinafter, referred to as “interpolation image signal”) of the interpolating image generated using the normal interpolation process or the pre-interpolation process to the mixing part 149 at a predetermined timing.

The mixing part 149 mixes the interpolation image signal provided from the interpolating image generating part 145 between the previous input image signal provided from the frame memory 141 and the target input image signal provided from the OSD superimposing section 130, and outputs the picture signal after interpolation (hereinafter sometimes referred to as “output picture signal”) to the panel drive section 160. As a result, the frame rate of the output picture signal output from the mixing part 149 becomes twice the frame rate of the input picture signal.

Thus, if false operation occurs as a result of performing the frame rate conversion process on the input image signal superimposed with the OSD image signal, the interpolation process using motion vector is not performed at least for the OSD image portion without motion between the adjacent frames and the previous input image signal itself is used as the interpolation image signal in the frame rate conversion section 140. Therefore, the generation of a mistaken interpolation image signal is suppressed, the stable interpolated image signal can be output, and false operation can be prevented.

The normal interpolation process and the pre-interpolation process, which are the methods of the frame rate conversion process (interpolation process), by the frame rate conversion section 140 will now be described with reference to FIG. 6. As shown in FIG. 6A, a case where input image signals A, B, and C of three consecutive frames are input in order to the frame rate conversion section 140 will be described.

In the normal interpolation process, assuming the input image signal B is the target input image signal, the motion vector of the input image signal B is detected using the input image signal B and the input image signal A or the previous input image signal. Using the detected motion vector, the input image signal B which is the target input image signal and the input image signal A which is the previous input image signal moved using the motion vector are mixed, whereby an interpolation image signal AB at an intermediate time between the input image signal A and the input image signal B is generated, as shown in FIG. 6B. Similarly, assuming the input image signal C is the target input image signal, an interpolation image signal BC at an intermediate time between the input image signal B and the input image signal C is generated using the motion vector of the input image signal C, as shown in FIG. 6B.

In the pre-interpolation process, assuming the input image signal B is the target input image signal, the input image signal A which is the previous input image signal is generated as is as the interpolation image signal, as shown in FIG. 6C. Similarly, assuming the input image signal C is the target input image signal, the input image signal B which is the previous input image signal is generated as is as the interpolation image signal, as shown in FIG. 6C.

The image signal of after interpolation output from the mixing part 149 of FIG. 5 will be described with reference again to FIG. 2.

As described above, in the example shown in FIG. 2, the input picture signal includes image signals of two images of frame 30 at time t(n) and frame 50 at time t(n+1), where the frame 30 and the frame 50 are respectively drawn with a black doughnut-shaped FIG. 60 on a white background. The frame rate conversion process is performed on the OSD superimposed images 35, 55 in which the image signal of the OSD image 70 displaying a menu screen (MENU) is superimposed on the image signals of frame 30 and frame 50.

In the example shown in FIG. 2C, the OSD superimposed image 35 at time t(n) is first input as an input signal to the frame rate conversion section 140. The conversion control signal indicating that the indicating that the OSD image 70 is superimposed on the OSD superimposed image 35 is input from the control section 120 to the frame rate conversion section 140. As shown in FIG. 2C, the frame rate conversion section 140 performs the pre-interpolation process or the exceptional process only on the portion of the OSD image 70, and performs the normal interpolation process using motion vector on the other portion (FIG. 60).

As a result, an interpolating image 45c of a state moved to a position at an arbitrary time t(m) between time t(n) and time t(n+1) is generated based on the motion vector at the same position as the OSD superimposed image 35 with respect to the portion of the OSD image 70 and detected by comparing the OSD superimposed image 35 and the OSD superimposed image 55 with respect to the portion of the FIG. 60. The frame rate conversion section 140 increases the speed of the frame rate without producing the portion of false operation 70a as shown in FIG. 2B by inserting the interpolating image 45c between the OSD superimposed image 35 and the OSD superimposed image 55.

In the example shown in FIG. 2D, the OSD superimposed image 35 at time t(n) is input as the input signal to the frame rate conversion section 140. The conversion control signal indicating that the indicating that the OSD image 70 is superimposed on the OSD superimposed image 35 is input from the control section 120 to the frame rate conversion section 140. As shown in FIG. 2D, the frame rate conversion section 140 performs the pre-interpolation process or the exceptional process on the entire OSD superimposed image 35.

As a result, an interpolating image 45d using the OSD superimposed image 35 as is for the interpolating image is generated. The frame rate conversion section 140 increases the speed of the frame rate without producing the portion of false operation 70a as shown in FIG. 2B by inserting the interpolating image 45d between the OSD superimposed image 35 and the OSD superimposed image 55.

The functions of the frame rate conversion section 140 have been described in detail above, and now the description on the function configuration of the display apparatus 100 according to the present embodiment will be continued with reference again to FIG. 3.

The panel drive section 160 performs processes such as D/A (Digital/Analog) conversion on the picture signal input from the frame rate conversion section 140. The panel drive section 160 drives the display panel 170 such as a liquid crystal panel based on the resultant analog signal, and displays an image in frame units on the display panel 170.

One example of the function of the display apparatus according to the present embodiment has been described above. Each component described above may be configured using a general purpose member or circuit, or may be configured by hardware specialized for the function of each component. The function of each component may all be executed by the CPU etc. Therefore, the configuration to use can be appropriately changed according to the technical level of when implementing the present embodiment.

### (Hardware Configuration of Display Apparatus 100)

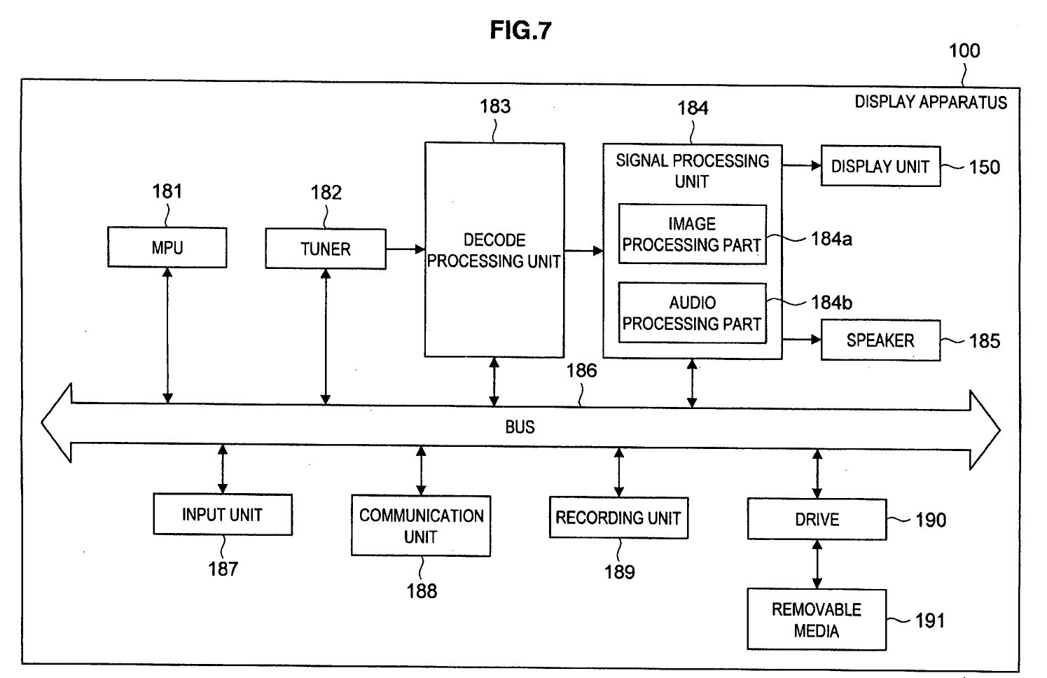

One example of a hardware configuration of the display apparatus 100 according to the present embodiment will be described below with reference to FIG. 7. FIG. 7 is a block diagram showing the hardware configuration of the display apparatus 100 according to the present embodiment.

As shown in FIG. 7, in the display apparatus 100, an MPU (Micro Processing Unit) 181, a tuner 182, a decode processing unit 183, a signal processing unit 184 connected with the display unit 150 and a speaker 185, an input unit 187, a communication unit 188, a recording unit 189, and a drive 190 are connected to each other by way of a bus 186, where the display apparatus 100 receives electric wave of each pixel of the image in frame units of time series and a digital signal of a audio of a program (hereinafter, referred to as program signal), and outputs the image and the audio of the program.

The MPU 181 executes the program installed in the recording unit 189 to execute various processes in correspondence to the commands etc. input from the input unit 187. The MPU 181 controls the tuner 182 in correspondence to the command of channel switching, and changes the channel corresponding to the program signal received by the tuner 182. The MPU 181 changes the input source of the program signal to input to the decode processing unit 183 from one to the other of the tuner 182 and an external device (not shown) connected to the communication unit 188 in correspondence to the command of input switching.

The MPU 181 provides the superimpose command signal to the signal processing unit 184 in correspondence to the command to start the display of the OSD image. Furthermore, the MPU 181 provides the conversion control signal to the signal processing unit 184 when the input image signal superimposed with the OSD image is input to an image processing part 184a. The provision of the conversion control signal is performed in the display apparatus 100 according to the present embodiment, and is not performed in a display apparatus 200 according to a second embodiment to be hereinafter described but performed by external equipment other than the display apparatus 200.

The MPU 181 installs a program downloaded by the communication unit. 188, and a program recorded in a removable media 191 attached to the driver 190 such as magnetic disc, optical disc, magneto-optical disc, semiconductor memory, and the like in the recording unit 189 as necessary.

According to the control of the MPU 181, the tuner 182 receives the electric wave of the program signal of the desired channel of the user radiated from a broadcast station (not shown), and demodulates the same. The tuner 182 provides the program signal obtained as a result of demodulation to the decode processing unit 183.

According to the control of the MPU 181, the decode processing unit 183 decodes the coded program signal provided from the tuner 182 with a predetermined method such as MPEG2 (Moving Picture Experts Group phase 2) etc., and provides the resultant program signal to the signal processing unit 184.

The signal processing unit 184 is configured by the image processing part 184a and an audio processing part 184b. The image processing part 184a performs superimposition of the OSD image signal according to the superimpose command signal provided from the MPU 181. The image processing part 184a performs processes such as interpolation and D/A conversion of the image signal at an intermediate time of the consecutive image signals with respect to the resultant image signal. In this case, the pre-interpolation process is performed according to the conversion control signal provided from the MPU 181. The image processing part 184a provides the image signal or the resultant analog signal to the display unit 150, and displays the image on the display unit 150.

The audio processing part 184b performs D/A conversion etc. on the audio signal of the program signals provided from the decode processing unit 183, and provides the audio signal or the resultant analog signal to the speaker 185 to output audio to the outside.

The input unit 187 is configured by a receiving part for receiving commands transmitted from a remote controller (not shown), a button, a keyboard, a mouse, a switch, and the like, and accepts commands from the user. The input unit 187 provides various commands to the MPU 181 via the bus 186 in response to the commands from the user.

For instance, the input unit 187 provides the command of channel switching to the MPU 181 in response to the command of channel switching from the user, and provides the command of input switching to the MPU 181 in response to the command of input switching from the user. The input unit 187 provides the command to start or end the display of the OSD image to the MPU 181 in response to the command to start or end the display of the OSD image from the user.

The communication unit 188 transmits and receives various data by way of a network such as Internet (not shown). The communication unit 188 downloads a predetermined program from a server (not shown) via a network, and provides the same to the MPU 181. The recording unit 189 records programs to be executed by the MPU 181 and various data as necessary.

The removable media 191 is attached to the drive 190 as necessary. The drive 190 drives the removable media 191, reads out the program, the data, and the like recorded thereon, and provides the same to the MPU 181 via the bus 186.

The configuration of the display apparatus 100 according to the present embodiment described above is applicable to various display apparatuses having a frame rate conversion function such as cam coder, digital still camera, DVD (Digital Versatile Disk) recorder, video recorder, BD (Blu-ray Disk) recorder, television (TV) receiver, projector, portable telephone, and one segment broadcast TV.

One example of the hardware configuration capable of realizing the functions of the display apparatus according to the present embodiment has been shown above. Each component described above may be configured using a general purpose member, or may be configured by hardware specialized for the function of each component. Therefore, the hardware configuration to use can be appropriately changed according to the technical level of when implementing the present embodiment.

### (Picture Display Method Using Display Apparatus 100)

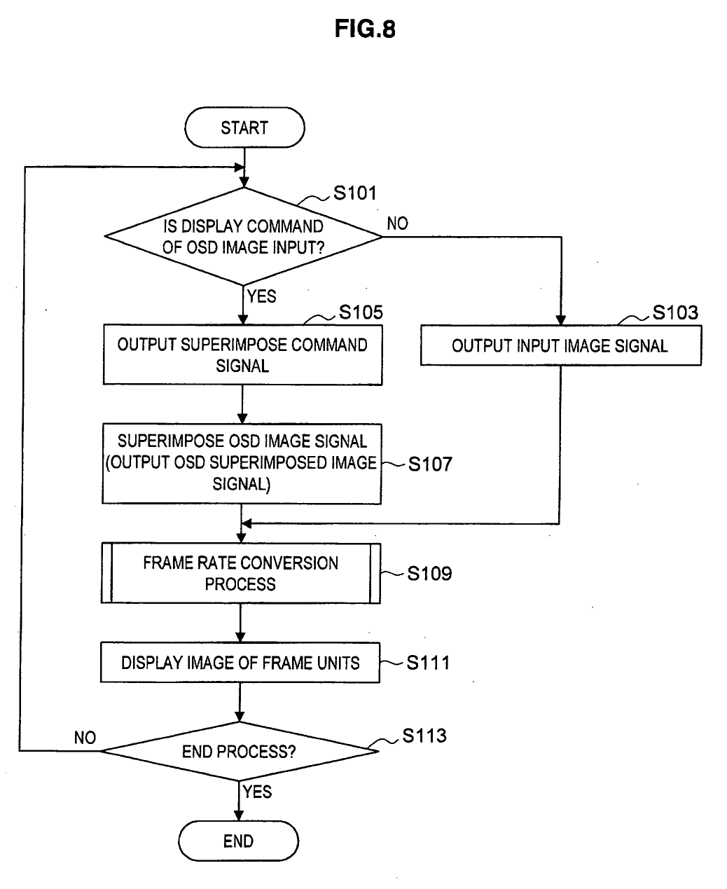

The configuration and the function of the display apparatus 100 according to the present embodiment have been described in detail above, and the flow of process of the picture display method using the display apparatus 100 according to the present embodiment will be described with reference to FIG. 8. FIG. 8 is a flowchart showing the flow of process of the picture display method using the display apparatus 100 according to the present embodiment. In the following description, a mode of performing the pre-interpolation process will be described using the first mode described above, that is, a mode of performing the pre-interpolation process only on the OSD image portion by way of example.

The process of the picture display method according to the present embodiment starts when the power of the display apparatus 100 is turned ON.

First, as shown in FIG. 8, the control section 120 (MPU 181 thereof) judges whether or not the display command of the OSD image is input from the input unit 187 (S101). As a result of judgment, if judged that the display command of the OSD image is not input, the control section 120 outputs to the OSD superimposing section 130 a signal of instructing the frame rate conversion section 140 to output the input image signal contained in the input picture signal input to the OSD superimposing section as it is. The OSD superimposing section 130 receiving such signal outputs the input image signal to the frame rate conversion section 140 (S103).

If judged that the display command of the OSD image is input as a result of the judgment of step S101, the MPU 181 of the control section 120 performs a control to have the superimpose command signal output part 121 output the superimpose command signal. The superimpose command signal output part 121 thus outputs the superimpose command signal to the OSD superimposing section 130 (S105).

The OSD superimposing section 130 input with the superimpose command signal generates the OSD superimposed image signal in which the OSD image signal is superimposed on the input image signal contained in the input picture signal, and outputs the same to the frame rate conversion section 140 (S107).

The frame rate conversion section 140 input with the input image signal itself or the OSD superimposed image signal from the OSD superimposing section 130 performs the frame rate conversion process on the input image signal (S109). The details of the frame rate conversion process will be hereinafter described.

The frame rate conversion section 140 outputs the image signal after frame rate conversion to the display unit 150. The display unit 150 displays the image in frame unit based on the image signal input from the frame rate conversion section 140 (S111).

Lastly, the control section 120 determines whether or not to terminate the process of picture display based on the command etc. from the input unit 187, terminates the process when determined to terminate, and again repeats the processes from step S101 to step S111 when determined not to terminate.

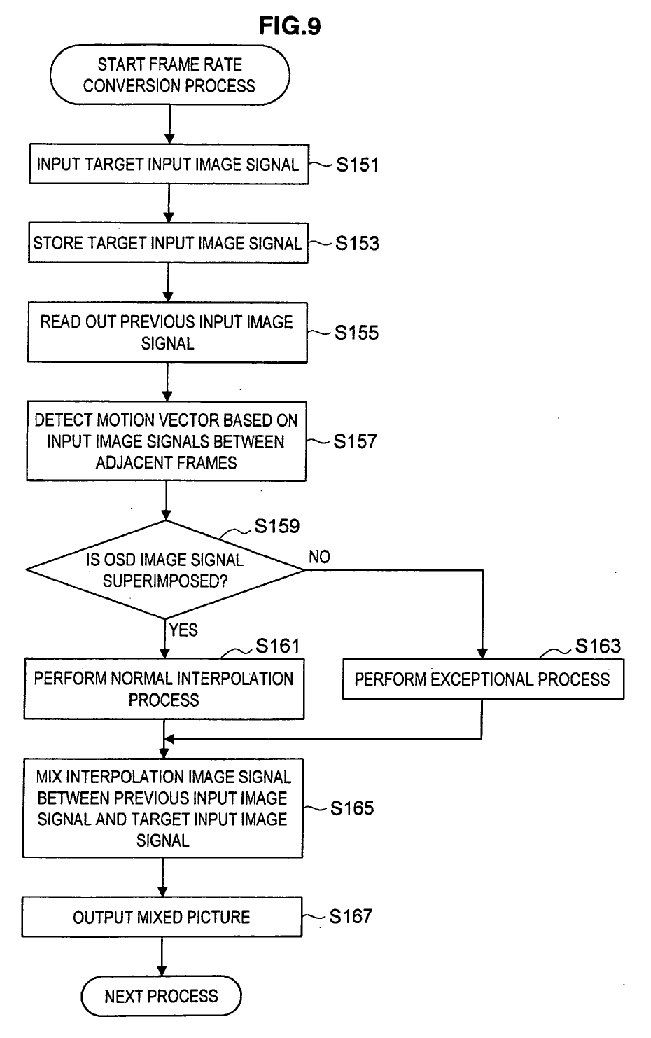

The flow of the frame rate conversion process according to the present embodiment will be described in detail below with reference to FIG. 9. FIG. 9 is a flowchart showing a flow of the frame rate conversion process according to the present embodiment.

As shown in FIG. 9, the frame rate conversion process according to the present embodiment starts when the input image signal serving as a target (hereinafter, referred to as “target input image”) is input to the frame rate conversion section 140 (S151). When the target input image signal is input to the frame rate conversion section 140 in step S151, the frame memory 141 of the frame rate conversion section 140 stores the input target input image signal (S153). The target input image signal input to the frame rate conversion section 140 is also provided to the motion vector detecting part 143 and the mixing part 149.

The frame memory 141 then reads out the input image signal (hereinafter, referred to as “previous input image signal”) corresponding to the frame one before the frame related to the target input image signal, and provides the same to the motion vector detecting part 143, the interpolating image generating part 145, and the mixing part 149 (S155).

The motion vector detecting part 143 detects the motion vector of the target input image signal based on the input image signal between adjacent frames, that is, based on the target input image signal input from the OSD superimposing section 130 and the previous input image signal provided from the frame memory 141 (S157). For instance, the motion vector detecting part 143 detects the motion vector in block units by performing a match of a standard block set for the target input image signal and a reference block of the same size as the standard block set for the previous input image signal according to the block matching method. The motion vector detecting part 143 provides the detected motion vector in block unit to the interpolating image generating part 145.

The conversion method determining part 147 determines whether or not the OSD image signal is superimposed on the picture signal input from the OSD superimposing section 130 to the frame rate conversion section 140 (S159). The conversion method determining part 147 determines that the OSD image signal is superimposed on the picture signal input from the OSD superimposing section 130 to the frame rate conversion section 140 when the conversion control signal is input from the control section 120 (from the conversion control signal output part 123); and determines that the OSD image signal is not superimposed on the picture signal input from the OSD superimposing section 130 to the frame rate conversion section 140 when the conversion control signal is not input from the control section 120 (from the conversion control signal output part 123).

If determined that the OSD image signal is not superimposed on the picture signal input to the frame rate conversion section 140 as a result of determination in S159, the interpolating image generating part 145 performs the normal interpolation process (S161). That is, the interpolating image generating part 145 moves the previous input image signal provided from the frame memory 141 in block units using the motion vector in block units provided from the motion vector detecting part 143, and generates an interpolating image which interpolates the image signal at an intermediate time between the target input image signal and the previous input image signal, with respect to the entire input image signal.

If determined that the OSD image signal is superimposed on the picture signal input to the frame rate conversion section 140 as a result of the determination in step S159, the interpolating image generating part 145 performs the exceptional process (S163). That is, the interpolating image generating part 145 uses the previous input image signal provided from the frame memory 141 as it is for the interpolating image signal, and generates an interpolating image which interpolates the image signal at an intermediate time between the target input image signal and the previous input image signal, with respect to the OSD image signal portion of the input image signal (pre-interpolation process). The interpolating image generating part 145 performs the normal interpolation process using motion vector with respect to the remaining portions other than the OSD image signal portion. The interpolating image generating part 145 provides the image signal of the interpolating image (hereinafter, referred to as “interpolation image signal”) generated using the normal interpolation process or the pre-interpolation process as described above to the mixing part 149 at a predetermined timing.

The mixing part 149 mixes the interpolation image signal provided from the interpolating image generating part 145 between the previous input image signal provided from the frame memory 141 and the target input image signal provided from the OSD superimposing section 130 (S165). The mixing part 149 outputs the picture signal after mixing (hereinafter sometimes referred to as “output picture signal”) to the panel drive section 160 (S167). As a result, the frame rate of the output picture signal output from the mixing part 149 becomes twice the frame rate of the input picture signal.

Thus, if false operation occurs as a result of performing the frame rate conversion process on the input image signal superimposed with the OSD image signal, the interpolation process using motion vector is not performed at least for the OSD image portion without motion between the adjacent frames and the previous input image signal itself is used as the interpolation image signal in the frame rate conversion section 140. Therefore, the generation of a mistaken interpolation image signal is suppressed, the stable interpolated image signal can be output, and false operation can be prevented.

### Second Embodiment

### (Function Configuration of Display Apparatus 200)

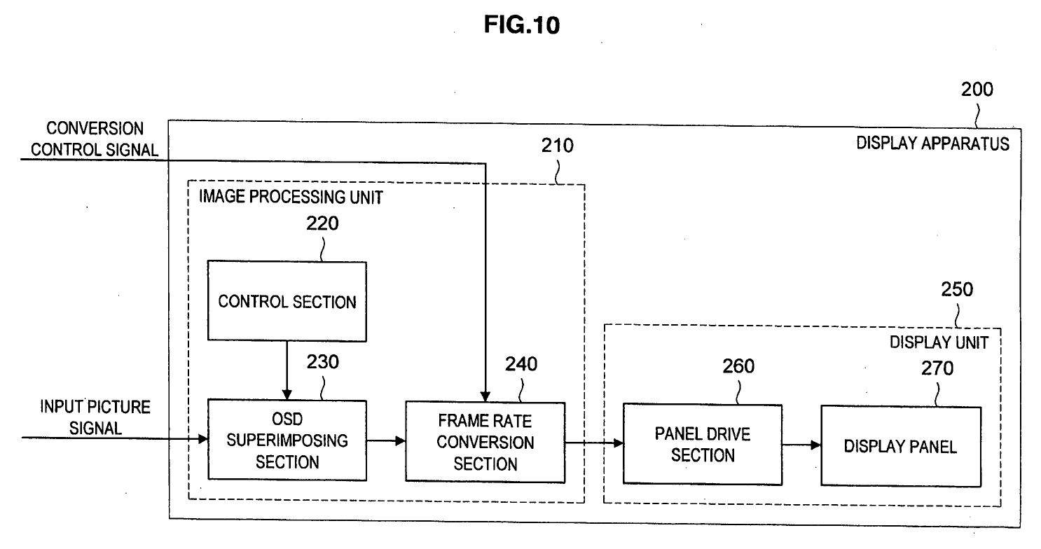

The configuration of the display apparatus 200 according to a second embodiment of the present invention will be described with reference to FIG. 10. FIG. 10 is a block diagram showing a function configuration of the display apparatus 200 according to the second embodiment of the present invention.

As shown in FIG. 10, the display apparatus 200 includes an image processing unit 210 for performing a frame rate conversion process of converting a frame rate using an interpolating image generated based on the motion vector between adjacent frames with respect to a picture signal which is a collection of image signals in plural frame units along time series; and a display unit 250 for displaying a picture based on the picture signal after frame rate conversion process. More specifically, the image processing unit 210 mainly includes a control section 220, an OSD superimposing section 230, and a frame rate conversion section 240; and the display unit 250 mainly includes a panel drive section 260 and a display panel 270.

The display apparatus 200 according to the present embodiment differs from the display apparatus 100 according to the first embodiment described above in that the input of the conversion control signal is made from external equipment connectable to the display apparatus 200 instead of from the control section 220. Therefore, the function configuration of the control section 220 is similar to the control section 12 in the general display apparatus 10. The detailed description of the function configuration of the control section 220 will be omitted herein.

The function configurations of the OSD superimposing section 230, the frame rate conversion section 240, the panel drive section 260, and the display panel 270 are respectively similar to the OSD superimposing section 130, the frame rate conversion section 140, the panel drive section 160, and the display panel 170 in the display apparatus 100 according to the first embodiment, and thus detailed description will be omitted.

One example of the function of the display apparatus according to the present embodiment has been described above. Each component described above may be configured using a general purpose member or circuit, or may be configured by hardware specialized for the function of each component. The function of each component may all be executed by the CPU etc. Therefore, the configuration to use can be appropriately changed according to the technical level of when implementing the present embodiment.

The function of the display apparatus 200 according to the present embodiment can be realized with a configuration similar to the hardware configuration of the display apparatus 100 according to the first embodiment, and thus the detailed description of the hardware configuration of the display apparatus 200 will be omitted. However, the provision of the conversion control signal is not performed in the MPU arranged in the display apparatus 200, and the provision of the conversion control signal is performed by the external equipment connectable to the display apparatus 200, as described above.

### (Picture Display Method Using Display Apparatus 200)

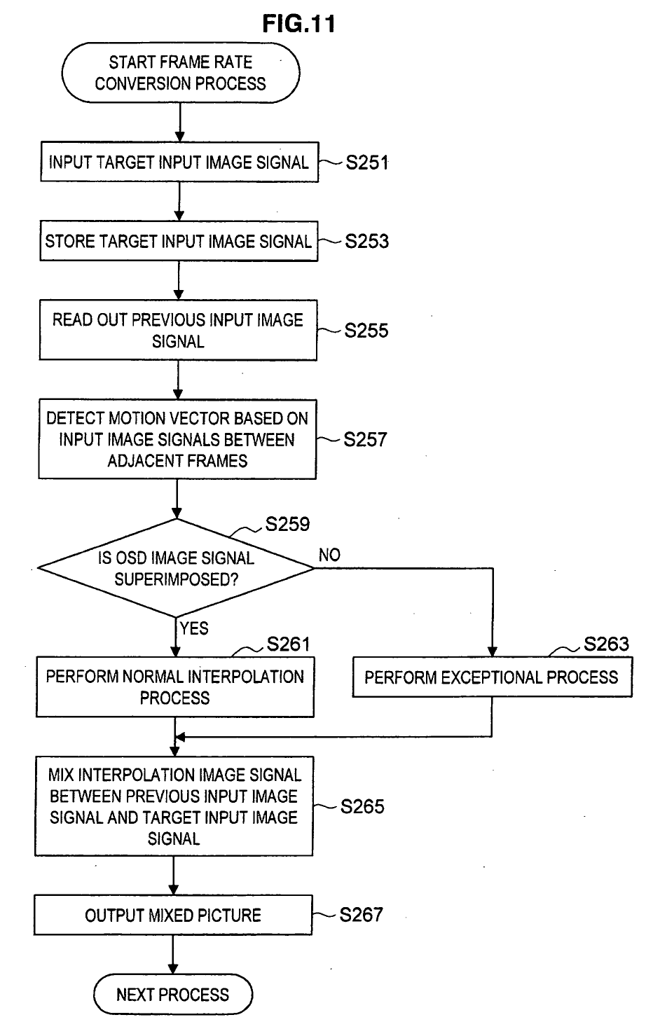

The configuration and the function of the display apparatus 200 according to the present embodiment have been described above, and the flow of process of the picture display method using the display apparatus 200 according to the present embodiment will be described with reference to FIG. 11. FIG. 11 is a flowchart showing the flow of process of the frame rate conversion process in the process of the picture display method using the display apparatus 200 according to the present embodiment. In the following description, a mode of performing the pre-interpolation process will be described using the mode of performing the pre-interpolation process only on the OSD image portion by way of example.

The processes other than the frame rate conversion process are the same as the first embodiment, and thus the detailed description will be omitted. The frame rate conversion process according to the present embodiment will be described below with reference to FIG. 11.

As shown in FIG. 11, the frame rate conversion process according to the present embodiment starts when the input image signal serving as a target (hereinafter, referred to as “target input image”) is input to the frame rate conversion section 240 (S251). When the target input image signal is input to the frame rate conversion section 240 in step S251, the frame memory of the frame rate conversion section 240 stores the input target input image signal (S253). The target input image signal input to the frame rate conversion section 240 is also provided to the motion vector detecting part and the mixing part.

The frame memory then reads out the input image signal (hereinafter, referred to as “previous input image signal”) corresponding to the frame one before the frame related to the target input image signal, and provides the same to the motion vector detecting part, the interpolating image generating part, and the mixing part (S255).

The motion vector detecting part detects the motion vector of the target input image signal based on the input image signal between adjacent frames, that is, based on the target input image signal input from the OSD superimposing section 230 and the previous input image signal provided from the frame memory (S257). For instance, the motion vector detecting part detects the motion vector in block units by performing a match of a standard block set for the target input image signal and a reference block of the same size as the standard block set for the previous input image signal according to the block matching method. The motion vector detecting part provides the detected motion vector in block unit to the interpolating image generating part.

The conversion method determining part of the frame rate conversion section 240 determines whether or not the OSD image signal is superimposed on the picture signal input from the OSD superimposing section 230 to the frame rate conversion section 240 (S259). The conversion method determining part determines that the OSD image signal is superimposed on the picture signal input from the OSD superimposing section 230 to the frame rate conversion section 240 when the conversion control signal is input from the external equipment connectable to the display apparatus 200; and determines that the OSD image signal is not superimposed on the picture signal input from the OSD superimposing section 230 to the frame rate conversion section 240 when the conversion control signal is not input from the external equipment.

If determined that the OSD image signal is not superimposed on the picture signal input to the frame rate conversion section 240 as a result of determination in S259, the interpolating image generating part performs the normal interpolation process (S261). That is, the interpolating image generating part moves the previous input image signal provided from the frame memory in block units using the motion vector in block units provided from the motion vector detecting part, and generates an interpolating image which interpolates the image signal at an intermediate time between the target input image signal and the previous input image signal, with respect to the entire input image signal.

If determined that the OSD image signal is superimposed on the picture signal input to the frame rate conversion section 240 as a result of the determination in step S259, the interpolating image generating part performs the exceptional process (S263). That is, the interpolating image generating part uses the previous input image signal provided from the frame memory as it is for the interpolating image signal, and generates an interpolating image which interpolates the image signal at an intermediate time between the target input image signal and the previous input image signal, with respect to the OSD image signal portion of the input image signal (pre-interpolation process). The interpolating image generating part performs the normal interpolation process using motion vector with respect to the remaining portions other than the OSD image signal portion. The interpolating image generating part provides the image signal of the interpolating image (hereinafter, referred to as “interpolation image signal”) generated using the normal interpolation process or the pre-interpolation process as described above to the mixing part at a predetermined timing.

The mixing part mixes the interpolation image signal provided from the interpolating image generating part between the previous input image signal provided from the frame memory and the target input image signal provided from the OSD superimposing section 230 (S265). The mixing part outputs the picture signal after mixing (hereinafter sometimes referred to as “output picture signal”) to the panel drive section 260 (S267). As a result, the frame rate of the output picture signal output from the mixing part becomes twice the frame rate of the input picture signal.

Thus, if false operation occurs as a result of performing the frame rate conversion process on the input image signal superimposed with the OSD image signal, the interpolation process using motion vector is not performed at least for the OSD image portion without motion between the adjacent frames and the previous input image signal itself is used as the interpolation image signal in the frame rate conversion section 240. Therefore, the generation of a mistaken interpolation image signal is suppressed, the stable interpolated image signal can be output, and false operation can be prevented.

### Third Embodiment

### (Function Configuration of Display Apparatus 300)

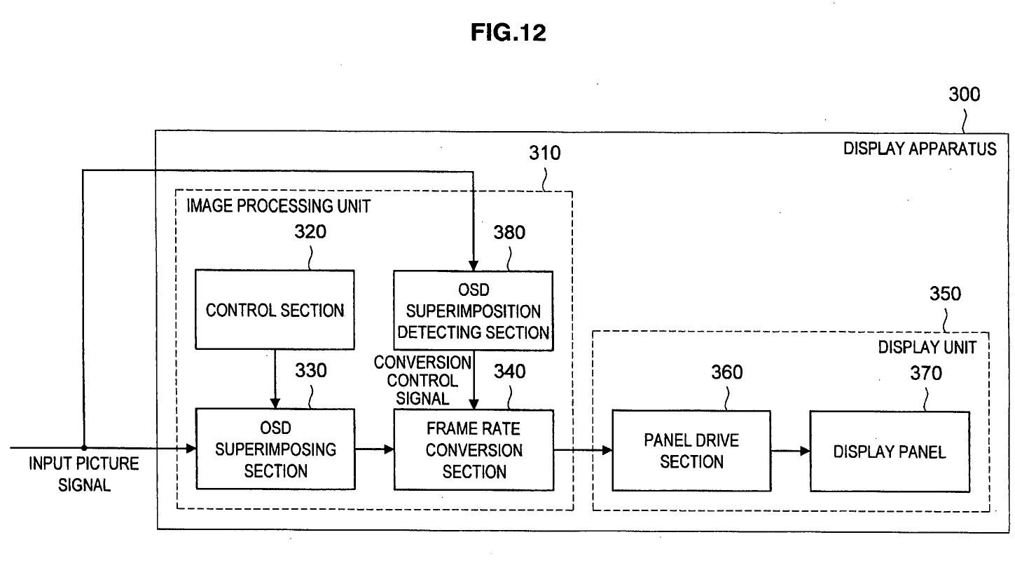

The configuration of the display apparatus 300 according to a third embodiment of the present invention will be described with reference to FIG. 12. FIG. 12 is a block diagram showing a function configuration of the display apparatus 300 according to the third embodiment of the present invention.

As shown in FIG. 12, the display apparatus 300 includes an image processing unit 310 for performing a frame rate conversion process of converting a frame rate using an interpolating image generated based on the motion vector between adjacent frames with respect to a picture signal which is a collection of image signals in plural frame units along time series; and a display unit 350 for displaying a picture based on the picture signal after frame rate conversion process. More specifically, the image processing unit 310 mainly includes a control section 320, an OSD superimposing section 330, a frame rate conversion section 340, and an OSD superimposition detecting section 380; and the display unit 350 mainly includes a panel drive section 360 and a display panel 370.

The display apparatus 300 according to the present embodiment differs from the display apparatus 100 and the display apparatus 200 according to the first and the second embodiments described above in that the input of the conversion control signal is made from the OSD superimposition detecting section 320 instead of from the control section 320. Therefore, the function configuration of the control section 320 is similar to the control section 12 in the general display apparatus 10. The detailed description of the function configuration of the control section 320 will be omitted herein.

The function configurations of the OSD superimposing section 330, the frame rate conversion section 340, the panel drive section 360, and the display panel 370 are respectively similar to the OSD superimposing section 130, the frame rate conversion section 140, the panel drive section 160, and the display panel 170 in the display apparatus 100 according to the first embodiment, and thus detailed description will be omitted.

The configuration of the OSD superimposition detecting section 380 which is a configuration unique to the display apparatus 300 according to the present embodiment will be described below.

The OSD superimposition detecting section 380 detects input of the OSD superimposed picture signal to the frame rate conversion section 340, and outputs the conversion control signal indicating that the OSD superimposed picture signal is input to the frame rate conversion section 340 to the frame rate conversion section 340. The frame rate conversion section 340 input with the conversion control signal from the OSD superimposition detecting section 380 performs frame rate conversion process using an image at least one part of which is the same as the frame immediately before as an interpolating image with respect to the portion including at least the OSD image signal.

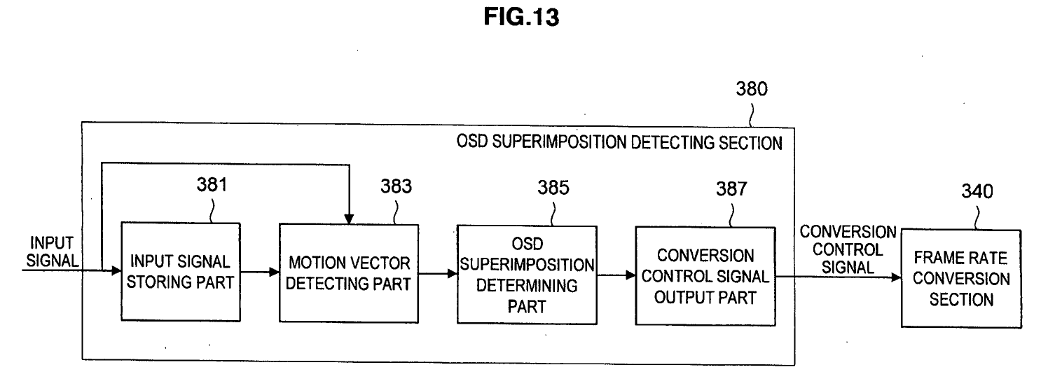

The configuration of the OSD superimposition detecting section 380 will be described in detail with reference to FIG. 13. FIG. 13 is a block diagram showing a detailed function configuration of the OSD superimposition detecting section 380 according to the present embodiment.

As shown in FIG. 13, the OSD superimposition detecting section 380 mainly includes an input signal storing part 381, a motion vector detecting part 383, an OSD superimposition determining part 385, and a conversion control signal output part 387.

The input signal storing part 381 stores the input image signal input to the OSD superimposition detecting section 380 in frame units. The input signal storing part 381 reads out the previously stored input image signal, that is, the input image signal of one frame before the input image signal input to the OSD superimposition detecting section 380, and provides the same to the motion vector detecting part 383. The input image signal is also provided to the motion vector detecting part 383.

The motion vector detecting part 383 detects the motion vector of the target input image signal with the input image signal input to the OSD superimposition detecting section 380 as the input image signal to be detected (target input image signal). That is, the motion vector of the target input image signal is detected based on the target input image signal, and the input image signal (previous input image signal) of one frame before the target input image signal provided from the input signal storing part 381.

For instance, the motion vector detecting part 383 detects the motion vector in block units by performing a match of a standard block set for the target input image signal and a reference block of the same size as the standard block set for the previous input image signal according to the block matching method. The motion vector detecting part 383 provides the detected motion vector in block unit to the OSD superimposition determining part 385.

The OSD superimposition determining part 385 first judges whether or not a region where the motion vector is not detected exists in the target input image signal based on the motion vector detected by the motion vector detecting part 383. If the region (hereinafter, referred to as “target region”) where the motion vector is not detected exists in the target input image signal, whether or not the target region is greater than the region (hereinafter, referred to as “OSD display region”) set in advance to perform the OSD display is judged. This judgment is made by comparing the area of the target region and the area of the OSD display region. If judged that the target region is greater than the OSD display region as a result of the judgment, the OSD superimposition determining part 385 outputs to the conversion control signal output part 387 a command signal commanding to output the conversion control signal.

The conversion control signal output part 387 generates the conversion control signal if the above command signal is input, and outputs the generated conversion control signal to the frame rate conversion section 340.

One example of the function of the display apparatus according to the present embodiment has been described above. Each component described above may be configured using a general purpose member or circuit, or may be configured by hardware specialized for the function of each component. The function of each component may all be executed by the CPU etc. Therefore, the configuration to use can be appropriately changed according to the technical level of when implementing the present embodiment.

The function of the display apparatus 300 according to the present embodiment can be realized with a configuration similar to the hardware configuration of the display apparatus 100 according to the first embodiment, and thus the detailed description of the hardware configuration of the display apparatus 300 will be omitted. The function of the OSD superimposition detecting section 380 can be realized by hardware such as MPU.

### (Picture Display Method Using Display Apparatus 300)

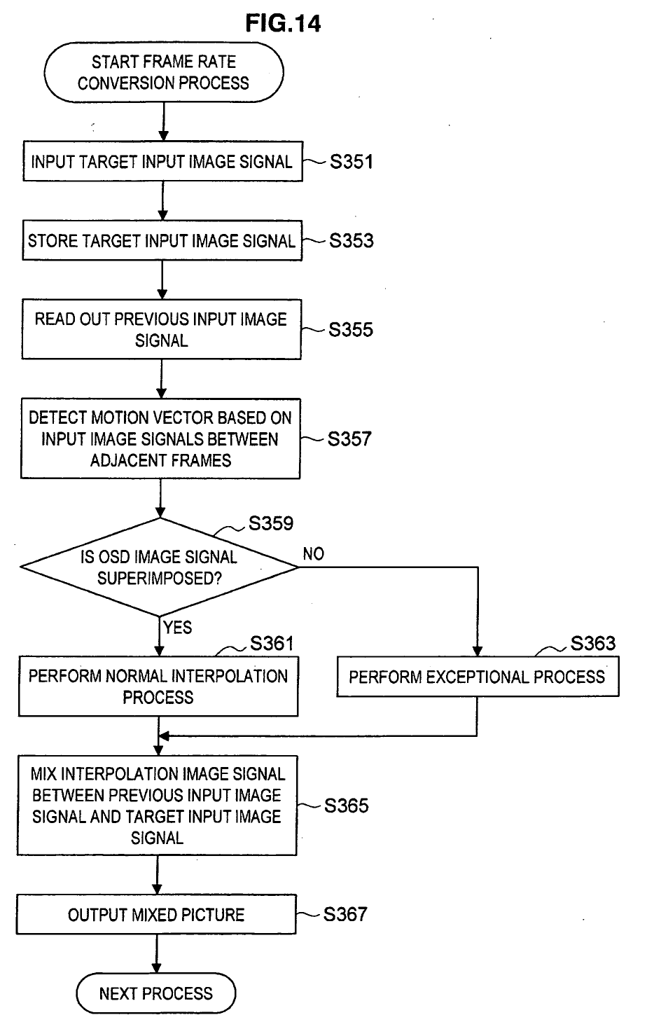

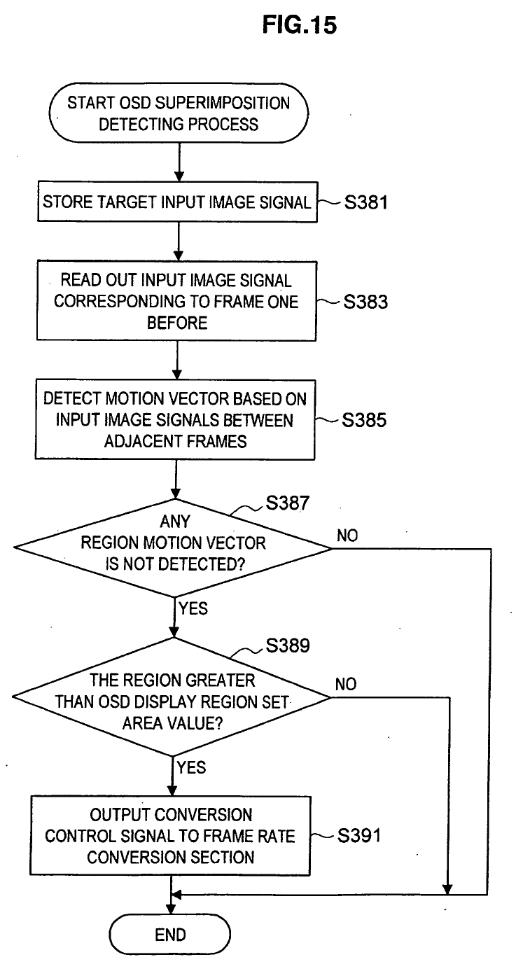

The configuration and the function of the display apparatus 300 according to the present embodiment have been described above, and the flow of process of the picture display method using the display apparatus 300 according to the present embodiment will be described with reference to FIGS. 14 and 15. FIG. 14 is a flowchart showing the flow of process of the frame rate conversion process in the process of the picture display method using the display apparatus 300 according to the present embodiment. FIG. 15 is a flowchart showing the flow of the OSD superimposition detecting process according to the present embodiment. In the following description, a mode of performing the pre-interpolation process will be described using the mode of performing the pre-interpolation process only on the OSD image portion by way of example.

The processes other than the frame rate conversion process and the OSD superimposition detecting process are the same as the first embodiment, and thus the detailed description will be omitted. The frame rate conversion process according to the present embodiment will be described below with reference to FIG. 14.

As shown in FIG. 14, the frame rate conversion process according to the present embodiment starts when the input image signal serving as a target (hereinafter, referred to as “target input image”) is input to the frame rate conversion section 340 (S351). When the target input image signal is input to the frame rate conversion section 340 in step S351, the frame memory of the frame rate conversion section 340 stores the input target input image signal (S353). The target input image signal input to the frame rate conversion section 340 is also provided to the motion vector detecting part and the mixing part.

The frame memory then reads out the input image signal (hereinafter, referred to as “previous input image signal”) corresponding to the frame one before the frame related to the target input image signal, and provides the same to the motion vector detecting part, the interpolating image generating part, and the mixing part (S355).

The motion vector detecting part detects the motion vector of the target input image signal based on the input image signal between adjacent frames, that is, based on the target input image signal input from the OSD superimposing section 330 and the previous input image signal provided from the frame memory (S357). For instance, the motion vector detecting part detects the motion vector in block units by performing a match of a standard block set for the target input image signal and a reference block of the same size as the standard block set for the previous input image signal according to the block matching method. The motion vector detecting part provides the detected motion vector in block unit to the interpolating image generating part.

The conversion method determining part of the frame rate conversion section 340 determines whether or not the OSD image signal is superimposed on the picture signal input from the OSD superimposing section 330 to the frame rate conversion section 340 (S359). The conversion method determining part determines that the OSD image signal is superimposed on the picture signal input from the OSD superimposing section 330 to the frame rate conversion section 340 when the conversion control signal is input from the OSD superimposition detecting section 380; and determines that the OSD image signal is not superimposed on the picture signal input from the OSD superimposing section 330 to the frame rate conversion section 340 when the conversion control signal is not input from the OSD superimposition detecting section 380.

If determined that the OSD image signal is not superimposed on the picture signal input to the frame rate conversion section 340 as a result of determination in S359, the interpolating image generating part performs the normal interpolation process (S361). That is, the interpolating image generating part moves the previous input image signal provided from the frame memory in block units using the motion vector in block units provided from the motion vector detecting part, and generates an interpolating image which interpolates the image signal at an intermediate time between the target input image signal and the previous input image signal, with respect to the entire input image signal.

If determined that the OSD image signal is superimposed on the picture signal input to the frame rate conversion section 340 as a result of the determination in step S359, the interpolating image generating part performs the exceptional process (S363). That is, the interpolating image generating part uses the previous input image signal provided from the frame memory as it is for the interpolating image signal, and generates an interpolating image which interpolates the image signal at an intermediate time between the target input image signal and the previous input image signal, with respect to the OSD image signal portion of the input image signal (pre-interpolation process). The interpolating image generating part performs the normal interpolation process using motion vector with respect to the remaining portions other than the OSD image signal portion. The interpolating image generating part provides the image signal of the interpolating image (hereinafter, referred to as “interpolation image signal”) generated using the normal interpolation process or the pre-interpolation process as described above to the mixing part at a predetermined timing.

The mixing part mixes the interpolation image signal provided from the interpolating image generating part between the previous input image signal provided from the frame memory and the target input image signal provided from the OSD superimposing section 330 (S365). The mixing part outputs the picture signal after mixing (hereinafter sometimes referred to as “output picture signal”) to the panel drive section 360 (S367). As a result, the frame rate of the output picture signal output from the mixing part becomes twice the frame rate of the input picture signal.

Thus, if false operation occurs as a result of performing the frame rate conversion process on the input image signal superimposed with the OSD image signal, the interpolation process using motion vector is not performed at least for the OSD image portion without motion between the adjacent frames and the previous input image signal itself is used as the interpolation image signal in the frame rate conversion section 340. Therefore, the generation of a mistaken interpolation image signal is suppressed, the stable interpolated image signal can be output, and false operation can be prevented.

The flow of the OSD superimposition detecting process according to the present embodiment will be described in detail with reference to FIG. 15.

As shown in FIG. 15, the input signal storing part 381 stores the input image signal input to the OSD superimposition detecting section 380 in frame units (S381). The input signal storing part 381 reads out the previously stored input image signal, that is, the input image signal of one frame before the input image signal input to the PSD superimposition detecting section 380 (S383) and provides the same to the motion vector detecting part 383. The input image signal is also provided to the motion vector detecting part 383.

The motion vector detecting part 383 detects motion vector based on the input image signal between adjacent frames (S385). Specifically, the motion vector detecting part 383 detects the motion vector of the target input image signal with the input image signal input to the OSD superimposition detecting section 380 as the input image signal to be detected (target input image signal). That is, the motion vector of the target input image signal is detected based on the target input image signal, and the input image signal (previous input image signal) of one frame before the target input image signal provided from the input signal storing part 381.

For instance, the motion vector detecting part 383 detects the motion vector in block units by performing a match of a standard block set for the target input image signal and a reference block of the same size as the standard block set for the previous input image signal according to the block matching method. The motion vector detecting part 383 provides the detected motion vector in block unit to the OSD superimposition determining part 385.

The OSD superimposition determining part 385 judges whether or not a region (target region) where the motion vector is not detected exists in the target input image signal based on the motion vector detected by the motion vector detecting part 383 (S387). If judged that the target region does not exist in the target input image signal as a result of the judgment in step S387, the OSD superimposition detecting section 380 terminates the OSD superimposition detecting process assuming the OSD superimposed image signal is not detected.

If judged that the target region exist in the target input image signal as a result of the judgment in step S387, whether or not the target region is greater than the region (hereinafter, referred to as “OSD display region”) set in advance to perform the OSD display is judged (S389). This judgment in S389 may be made by comparing the area of the target region and the area of the OSD display region. If judged that the target region is smaller than the OSD display region as a result of the judgment in step S389, the OSD superimposition determining part 385 terminates the OSD superimposition detecting process assuming the OSD superimposed image signal is not detected.

If judged that the target region is greater than the OSD display region as a result of the judgment in step S389, the OSD superimposition determining part 385 outputs to the conversion control signal output part 387 a command signal commanding to output the conversion control signal.

The conversion control signal output part 387 input with the above command signal generates the conversion control signal, outputs the generated conversion control signal to the frame rate conversion section 340 (S391), and terminates the OSD superimposition detecting process.

It should be understood by those skilled in the art that various modifications, combinations, sub-combinations and alterations may occur depending on design requirements and other factors insofar as they are within the scope of the appended claims or the equivalents thereof.

For instance, a case where the normal interpolation process and the pre-interpolation process are combined, or a case where only the pre-interpolation process is used has been described for the exceptional process in the first to the third embodiments, but any process can be performed as long as false operation involved in the OSD superimposition in the frame rate conversion process can be prevented.

What is claimed is:

1. A display apparatus comprising:
an image processing unit for performing a frame rate conversion process of converting a frame rate using an interpolating image generated based on a motion vector between adjacent frames with respect to a picture signal which is a collection of image signals of a plurality of frame units taken along a time-series; and
a display unit for displaying a picture based on the picture signal of after the frame rate conversion process; wherein
the image processing unit includes,
a control section for outputting a superimpose command signal representing a command to superimpose an OSD image signal for performing an OSD display on an input picture signal which is the picture signal input from an outside,
an OSD superimposing section, externally input with the input picture signal, for outputting an OSD superimposed picture signal having the OSD image signal superimposed on the input picture signal or the input picture signal according to an input of the superimpose command signal from the control section, and
a frame rate conversion section for performing the frame rate conversion process on the OSD superimposed picture signal or the input picture signal input from the OSD superimposing section; and
the frame rate conversion section performs the frame rate conversion process using an image at least one part of which is the same as a frame immediately before as the interpolating image when a conversion control signal indicating that the OSD superimposed picture signal is input to the frame rate conversion section is input from the control section.

2. The display apparatus according to claim 1, wherein
the frame rate conversion section performs the frame rate conversion process using an image where only the OSD display portion is the same as the frame immediately before as the interpolating image when the conversion control signal is input.

3. The display apparatus according to claim 1, wherein
the frame rate conversion section performs the frame rate conversion process using an image where only a region to be performed with the predefined OSD display is the same as the interpolating image when the conversion control signal is input.

4. The display apparatus according to claim 1, wherein
the frame rate conversion section performs the frame rate conversion process using an image entirely the same as the frame immediately before as the interpolating image when the conversion control signal is input.

5. A display apparatus comprising:
an image processing unit for performing a frame rate conversion process of converting a frame rate using an interpolating image generated based on a motion vector between adjacent frames with respect to a picture signal which is a collection of image signals of a plurality of frame units taken along a time-series; and
a display unit for displaying a picture based on the picture signal of after the frame rate conversion process; wherein
the image processing unit includes,
a control section for outputting a superimpose command signal representing a command to superimpose an OSD image signal for performing an OSD display on an input picture signal which is the picture signal input from an outside,
an OSD superimposing section, externally input with the input picture signal, for outputting an OSD superimposed picture signal having the OSD image signal superimposed on the input picture signal or the input picture signal according to an input of the superimpose command signal from the control section, and
a frame rate conversion section for performing the frame rate conversion process on the OSD superimposed picture signal or the input picture signal input from the OSD superimposing section; and
the frame rate conversion section performs the frame rate conversion process using an image at least one part of which is the same as a frame immediately before as the interpolating image when a conversion control signal indicating that the OSD superimposed picture signal is input to the frame rate conversion section is input from other external equipment of the display apparatus.

6. The display apparatus according to claim 5, wherein
the frame rate conversion section performs the frame rate conversion process using an image where only the OSD display portion is the same as the frame immediately before as the interpolating image when the conversion control signal is input.

7. The display apparatus according to claim 5, wherein
the frame rate conversion section performs the frame rate conversion process using an image where only a region to be performed with the predefined OSD display is the same as the interpolating image when the conversion control signal is input.

8. The display apparatus according to claim 5, wherein
the frame rate conversion section performs the frame rate conversion process using an image entirely the same as the frame immediately before as the interpolating image when the conversion control signal is input.

9. A display apparatus comprising:
an image processing unit for performing a frame rate conversion process of converting a frame rate using an interpolating image generated based on a motion vector between adjacent frames with respect to a picture signal which is a collection of image signals of a plurality of frame units taken along a time-series; and
a display unit for displaying a picture based on the picture signal of after the frame rate conversion process; wherein
the image processing unit includes,
a control section for outputting a superimpose command signal representing a command to superimpose an OSD image signal for performing an OSD display on an input picture signal which is the picture signal input from an outside,
an OSD superimposing section, externally input with the input picture signal, for outputting an OSD superimposed picture signal having the OSD image signal superimposed on the input picture signal or the input picture signal according to an input of the superimpose command signal from the control section,
a frame rate conversion section for performing the frame rate conversion process on the OSD superimposed picture signal or the input picture signal input from the OSD superimposing section, and
an OSD superimposition detecting section for detecting the input of the OSD superimposed picture signal to the frame rate conversion section; and
the frame rate conversion section performs the frame rate conversion process using an image at least one part of which is the same as a frame immediately before as the interpolating image when a conversion control signal indicating that the OSD superimposed picture signal is input to the frame rate conversion section is input from the OSD superimposition detecting section.

10. The display apparatus according to claim 9, wherein
the frame rate conversion section performs the frame rate conversion process using an image where only the OSD display portion is the same as the frame immediately before as the interpolating image when the conversion control signal is input.

11. The display apparatus according to claim 9, wherein
the frame rate conversion section performs the frame rate conversion process using an image where only a region to be performed with the predefined OSD display is the same as the interpolating image when the conversion control signal is input.

12. The display apparatus according to claim 9, wherein
the frame rate conversion section performs the frame rate conversion process using an image entirely the same as the frame immediately before as the interpolating image when the conversion control signal is input.
